(19) United States
(12) Patent Application Publication
(10) Pub. No.: US 2017/0054939 A1
(43) Pub. Date: Feb. 23, 2017

(54) AUDIO AND VIDEO PLAYER

(71) Applicants: LE HOLDINGS (BEIJING) CO., LTD., Beijing (CN); LE SHI ZHI XIN ELECTRONIC TECHNOLOGY (TIAN JIN) LIMITED, Beijing (CN)

(72) Inventor: Wei LIU, Beijing (CN)

(21) Appl. No.: 15/241,952

(22) Filed: Aug. 19, 2016

Related U.S. Application Data
(63) Continuation of application No. PCT/CN2016/082042, filed on May 13, 2016.

(30) Foreign Application Priority Data
Aug. 21, 2015 (CN) 201510522893.0

(51) Int. Cl. H04N 7/01; H04N 5/445

(52) U.S. Cl. CPC H04N 7/0127; H04N 5/44543; H04N 5/44504

(57) ABSTRACT

The embodiments of the present invention provides an audio and video player, including a processor, a video format conversion bridge chip and a motion compensation frame rate converter, wherein the processor, provided with an on screen display menu function module, is configured to produce on screen display menu data; the video format conversion bridge chip is configured to receive external video signals from an external signal source and the on screen display menu data, and converts the data format thereof, and then overlays the on screen display menu data through the motion compensation frame rate converter, thus presenting the external video signals having on screen display menu data on a display screen, and enabling the audio and video player to both have high-definition frames and the function of being suitable for executing large-scale software, so as to improve the user experience and willingness to use.

### CROSS REFERENCE TO RELATED APPLICATIONS

This application is a continuation of PCT international application No. PCT/CN2016/082042, filed May 13, 2016, which claims priority to Chinese Patent Application No. 201510522893.0, filed Aug. 21, 2015. The entire contents of these applications are incorporated herein by reference.

### TECHNICAL FIELD

The present invention relates to the field of multimedia technologies, and, more particularly, to an audio and video player.

### BACKGROUND

For a solution employed to execute audio and video playing functions, current audio and video players (such as a smart TV) can only meet the use demand of playing a video or playing a small game since the processing capacity of a processor thereof is lower. However, for the use demand of executing large-scale games, its processing capacity for large games is far insufficient. Therefore, if gainers want to execute operations of large-scale games through a general audio and video player, it is required to purchase an additional game machine to execute, such as Microsoft XBOX ONE or Sony PS4 for playing the large-scale games on a smart TV.

Therefore, the current audio and video player cannot comply with the use demand for one machine multi-purpose, and additional equipment is needed, which merely increases the cost, thus resulting in poor user experience so as to reduce their willingness to use the audio and video player.

### SUMMARY

The present invention provides an audio and video player which is configured to solve the problems in the related art that the use demand for one machine multi-purpose cannot be satisfied, which results in poor user experience and the willingness to use the audio and video player is reduced.

In order to implement the foregoing objects, the embodiments of the present application employ the following technical solutions.

According to a first aspect, it provides an audio and video player, including: a processor, a video format conversion bridge chip and a motion compensation frame rate converter. Wherein, the processor, provided with an on screen display menu function module, is configured to produce on screen display menu data. The video format conversion bridge chip, which is coupled to the processor and the motion compensation frame rate converter respectively, and may be optionally coupled to an external signal source, is configured to receive the on screen display menu data, and receive and convert the data format of external video signals from the external signal source, and transmit the converted external video signals and the on screen display menu data to the motion compensation frame rate converter respectively. The motion compensation frame rate converter, coupled between the video format conversion bridge chip and a display screen, is configured to receive and overlay the converted external video signals with the on screen display menu data and transmit to the display screen.

According to the audio and video player provided by the present invention, such as a smart TV, the video signals received by the audio and video player are suitable to be played on the display screen and on screen display menu can be presented synchronously through the configuration of the high-performance processor having performance indexes apparently higher than that of a general processor, serving the video format conversion bridge chip as a medium for transmitting the external video signals and on screen display menu data and capable of converting the data format of the external video signals and the on screen display menu data, and processing the external video signals into the high resolution and high frame rate video signals overlaid with the on screen display menu data by the motion compensation frame rate converter, so that the audio and video player not only has the efficacy of executing high power consumption software, but also can provide a function for viewing high-quality videos at the same time. Therefore, for the aspect of use, the audio and video player enables users to view high-quality videos, and can also meet the use demand for executing large-scale games at the same time, so that the entire audio-visual entertainment efficacy of the audio and video player is enhanced, the user experience is substantially improved, and the cost for additionally purchasing a game machine is saved.

### BRIEF DESCRIPTION OF THE DRAWINGS

In order to explain the technical solutions in the embodiments of the invention or in the prior art more clearly, the drawings used in the descriptions of the embodiments or the related art will be simply introduced hereinafter. It is apparent that the drawings described hereinafter are merely some embodiments of the invention, and those skilled in the art may also obtain other drawings according to these drawings without going through creative work.

FIG. 1 is a block diagram of a first embodiment of an audio and video player according to the present invention; and

FIG. 2 is a block diagram of a second embodiment of the audio and video player according to the present invention.

### PREFERRED EMBODIMENTS

To make the objects, technical solutions and advantages of the embodiments of the present invention more clearly, the technical solutions of the present invention will be clearly and completely described hereinafter with reference to the embodiments and drawings of the present invention. Apparently, the embodiments described are merely partial embodiments of the present invention, rather than all embodiments. Other embodiments derived by those having ordinary skills in the art on the basis of the embodiments of the invention without going through creative efforts shall all fall within the protection scope of the present invention.

The technical solutions provided by each embodiment of the present invention will be described in details with reference to the drawings hereinafter.

The audio and video player and/or audio and video output equipment disclosed by the embodiments of the present invention is configured to transmit the video signals to the display screen, wherein the audio and video player may be, but is not limited to a TV set, such as a smart TV, while the audio and video output equipment may be such a video and audio device like a DVD player or a set top box externally connected to the audio and video player. The above is exemplary and explanatory only, and is not intended for limitation.

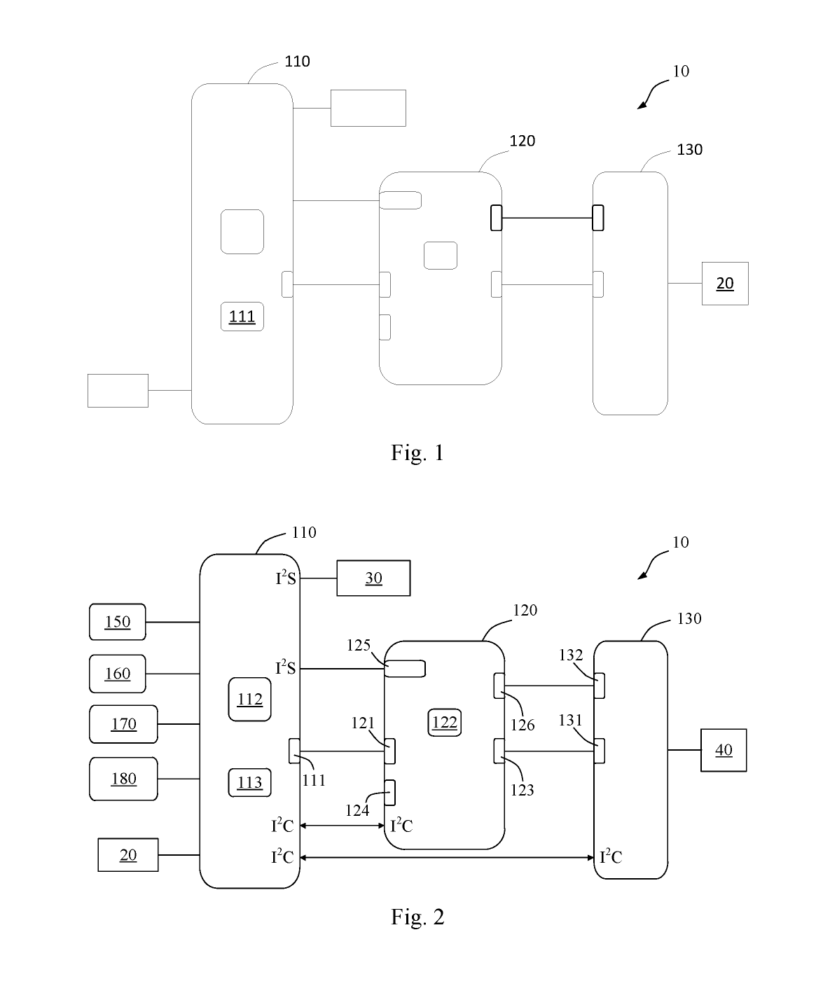

As shown in FIG. 1, an audio and video player 10 disclosed by a first embodiment of the present invention includes a processor 110, a video format conversion bridge chip 120 and a motion compensation frame rate converter 130. Wherein, the processor 110 is a processor having a master frequency and a register bit higher than that of a general processor. For example, if the general processor has 32 bits and a master frequency of 1.2 GHz, then the processor 110 may be a 64-bit processor having a master frequency of 2˜2.5 GHz, wherein this is a relative value, and any processor having performance indexes apparently higher than that of a general processor (i.e., so-called high-performance processor) is applicable to be served as the processor 110 of the audio and video player 10 in the embodiment of the present invention. Moreover, the processor, provided with an on screen display menu (on screen display) function module 111, is configured to produce on screen display menu data. The video format conversion bridge chip 120,which is coupled to the processor 110 and the motion compensation frame rate converter 130 respectively, and may be optionally coupled to an external signal source, is configured to receive the on screen display menu data, and receive and convert the data format of external video signals from the external signal source, and transmit the converted external video signals and the on screen display menu data to the motion compensation frame rate converter 130 respectively. Wherein, the external signal source is such a video and audio equipment like a DVD player or a set top box externally connected to the audio and video player 10, and the video format conversion bridge chip 120 is coupled to the externally connected video and audio device, and receives audio and video signals therefrom. The motion compensation frame rate converter 130, coupled between the video format conversion bridge chip 120 and a display screen 20, is configured to receive and overlay the converted external video signals with the on screen display menu data and transmit to the display screen 20.

In application, when the audio and video player 10 receives external audio and video signals through the video format conversion bridge chip 120 from such an external signal source like a DVD player or a set top box or the like, the data format of the external video signals from the external signal source (i.e., the video signals in the audio and video signals of the external signal source) is converted through the video format conversion bridge chip 120, for example, converted from data format HDMI to data format V-by-One, so that the data format is consistent with the receiving format of the motion compensation frame rate converter 130, and then the converted external video signals are transmitted to the motion compensation frame rate converter 130. Wherein, during the process of transmitting the converted external video signals from the video format conversion bridge chip 120 to the motion compensation frame rate converter 130, if the processor 110 receives an external operation instruction to produce corresponding on screen display menu data through the on screen display menu function module 111, the video format conversion bridge chip 120 receives the on screen display menu data and converts the data format, so that the data format of the on screen display menu data is converted into the data format that can be received by the motion compensation frame rate converter 130, and then transmitted to the motion compensation frame rate converter 130. It is to be understood that if the initial data format of the on screen display menu data is consistent with the data format that can be received by the motion compensation frame rate converter 130, the operation of converting the data format can be omitted.

Then, the motion compensation frame rate converter 130 can namely overlay the received on screen display menu data with the external video signals; or, and then transmit to the display screen 20.

Therefore, in the audio and video player provided by the embodiment of the present invention, the audio and video player possesses the ability of processing large-scale software, for example, large-scale games or other high power consumption software, through a manner of configuring the processor having performance indexes apparently higher than that of a general processor. Moreover, the external video signals received by the video format conversion bridge chip can be played on the display screen and the on screen display menu data can be presented at the same time by serving the video format conversion bridge chip as the medium for transmitting the external video signals and the on screen display menu data, and capable of converting the data format of the external video signals and the on screen display menu data. Moreover, high resolution and high frame rate video signals may be provided to the display screen through optimizing the converted video signals by the motion compensation frame rate converter, thus improving the quality of the display picture, and increasing the user experience at the same time.

Please refer to FIG. 2. An audio and video player 10 disclosed by a second embodiment of the present invention is coupled with a main signal source 30, an audio system 40 and a display screen 20. In addition, the audio and video player 10 disclosed by the embodiment of the present invention may also be externally connected with such an audio and video output equipment like a DVD player or a set top box or the like, and serve the audio and video output equipment as an external signal source to receive audio and video signals from these externally connected video and audio devices. Wherein, the main signal source 30 may be, but is not limited to a TV signal source, a signal source from internet or a signal source downloaded from a local end, while the external signal source is the foregoing audio and video signal source of the video and audio device externally connected to the audio and video player. Moreover, in the embodiment of the present invention, the audio system 40 and the display screen 20 may be, but are not limited to multimedia devices self-provided by the audio and video player 10, or multimedia devices externally connected to the audio and video player 10 in a detachable form.

The audio and video player 10 disclosed by the embodiment of the present invention includes a processor 110, a video format conversion bridge chip 120 and a motion compensation frame rate converter 130, wherein the processor 110 is coupled to the video format conversion bridge chip 120 and the motion compensation frame rate converter 130 respectively through an I²C (Inter-Integrated Circuit, inter-integrated circuit) bus. Moreover, the audio and video player 10 is also internally configured with one of an Ethernet module 150, a wired and/or wireless communication module 160 (such as a bluetooth module, a wifi module, a 2.4 G communication module, or the like), a power management module 170, a memory module 180 and combinations thereof, which are coupled to the processor 110 respectively.

It should be illustrated that, in the present invention, the processor 110 is a processor having a master frequency and a register bit higher than that of a general processor. For example, if the general processor has 32 bits and a master frequency of 1.2 GHz, then the processor 110 may be a 64-bit processor having a master frequency of 2˜2.5 GHz, wherein this is a relative value, and any processor having performance indexes apparently higher than that of a general processor (i.e., so-called high-performance processor) is applicable to be served as the processor 110 of the audio and video player 10 in the embodiment of the present invention.

The processor 110 is coupled to the main signal source 30 of the audio and video player 10 and is coupled to the audio system 40 through an I²S (Inter-IC Sound) audio bus (also called as integrated circuit built-in audio bus). the processor 110 is configured to receive the audio and video signals of the main signal source 30, for example, the audio and video signals transmitted to the processor 110 of the system from one of the Ethernet module 150 and the wired and/or wireless communication module 160 configured in the audio and video player 10, or the audio and video data read by the processor 110 from the memory module 180. Moreover, the processor 110 is also configured to transmit the audio signals in the received audio and video signals (i.e., the main audio signals from the main signal source 30) to the audio system 40 and transmit the video signals in the audio and video signals (i.e., the main video signals from the main signal source 30) to the video format conversion bridge chip 120. Wherein, the main signal source 30 may include, but is not limited to a TV signal source, a signal source from internet or a signal source downloaded from a local end, for example, the main signal source 30 includes: audio and video signals received by such wireless or wired communication modes like the Ethernet module 150 or the wired and/or wireless communication module 160; or audio and video data directly read from the memory module 180, and audio and video signals directly provided by the audio and video player 10 itself.

Furthermore, a first video format output interface 112, a processing module 113 and an on screen display menu function module 111 are electrically set on the processor 110. Wherein, the processing module 113 includes a central processing unit (central processing unit, CPU) and/or a graphic processing unit (graphic processing unit, GPU). While the first video format output interface 112 may be, but is not limited to one of a mobile high-definition video-audio standard interface (mobile high-definition link, MHL; referred to as MHL interface), an HDMI interface, a low voltage differential signaling (Low Voltage Differential Signaling, LVDS) interface, a DP interface (display port), an EDP interface (Embedded Display Port), an MIPI DSI interface (Mobile Industry Processor Interface-Display Serial Interface, mobile industry processor and display serial interface), a logic gate circuit interface (Transistor-Transistor Logic, TTL; referred to as TTL interface) and combinations thereof, and the processor 110 is namely coupled to the corresponding interface on the second video format conversion bridge chip 120 through the first video format output interface 112.

The on screen display menu function module 111 is configured to produce corresponding on screen display menu data according to an operation instruction received by the processor 110. For example, in a scenario of needing to use a menu, the processor 110 controls the on screen display menu function module 111 to produce on screen display menu data according to an external input instruction, for example, in the scenario that the audio and video player 10 of the present invention is a TV set, a function instruction requesting for displaying a control menu is transmitted to the processor 110 through a remote controller, then the processing module 113 of the processor 110 namely notifies the on screen display menu function module 111 to produce corresponding on screen display menu data according to the function instruction, and transmits the on screen display menu data to the video format conversion bridge chip 120 through the first video format output interface 112; or, the processor 110 overlays the on screen display menu data with the main video signals, and then the main video signals overlaid with the on screen display menu data is transmitted to the video format conversion bridge chip 120 through the first video format output interface 112.

A first video format input interface 121, a micro control unit (micro control unit, MCU) 122, a second video format output interface 123, an external audio and video input interface 124, an audio output interface 125 and an on screen menu output interface 126 are electrically set on the video format conversion bridge chip 120. The first video format input interface 121, coupled to the first video format output interface 112 of the processor 110, is configured to receive the main video signals from the main signal source 30, the overlaid main video signals (i.e., the main video signals overlaid with the on screen display menu data) or the on screen display menu data produced by the on screen display menu function module 111 from the processor 110. While the second video format output interface 123, which is coupled to a second video format input interface 131 electrically set on the motion compensation frame rate converter 130, is configured to transmit the converted main video signals or the converted external video signal to the motion compensation frame rate converter 130 after the video format conversion bridge chip 120 converts the data format of the main video signals from the main signal source 30, the overlaid main video signals or the external video signal from the external signal source.

Wherein, the data format of the first video format input interface 121 is the same as the data format of the first video format output interface 112 of the processor 110, for example, both of the two are data format HDMI; the data format of the second video format output interface 123 of the video format conversion bridge chip 120 is different from the data format of the first video format output interface 112 of the processor 110, for example, the data format is data format V-by-One. It is to be understood that because the second video format output interface 123 of the video format conversion bridge chip 120 and the second video format input interface 131 of the motion compensation frame rate converter 130 are a video signal output interface and a video signal input interface with corresponding data format, the data format of the second video format input interface 131 of the motion compensation frame rate converter 130 in the embodiment is also data format V-by-One.

The external audio and video input interface 124 of the video format conversion bridge chip 120 is configured to be coupled to the external signal source, for example, such an audio and video output equipment as a DVD player or set top box or the like, to facilitate receiving the external audio and video signals from the audio and video output equipment. Therefore, the data format of the external audio and video input interface 124 may be, but is not limited to such data format like an MHL interface, an HDMI interface, an LVDS interface, a DP interface, an EDP interface or an MIPI DSI interface or a TTL interface or the like, or the combinations of the foregoing data formats. While the audio output interface 125, coupled to the processor 110 through an I²S bus, is configured to transmit the converted external audio signals to the processor 110 after the format of the external audio signals from the external signal source is converted by the video format conversion bridge chip 120, to facilitate providing the audio signals to the audio system 40 to play. For example, after the external audio signals in data format HDMI are converted into the external audio signal in I²S, the signals are transmitted to the processor 110 through an I²S bus; or in some cases, the external audio signals in data format HDMI are firstly converted into data format SPDIF, then converted into data format I²S from data format SPDIF, and then transmitted to the processor 110.

While the on screen menu output interface 126 of the video format conversion bridge chip 120 is coupled to an interface with corresponding data format on the motion compensation frame rate converter 130, for example, an on screen menu input interface 132 that is electrically set on the motion compensation frame rate converter 130. Wherein, the on screen menu output interface 12 and the first video format input interface 121 of the video format conversion bridge chip 120 may either be interfaces with mutually corresponding data formats or with different data formats; if the data format of the on screen menu output interface 126 is different from that of the first video format input interface 121, then the data format of the on screen display menu data is further converted after the video format conversion bridge chip 120 receives the on screen display menu data, so that the data format of the on screen display menu data is consistent with the transmission format of the on screen menu output interface 126, to facilitate transmitting to the motion compensation frame rate converter 130.

The motion compensation frame rate converter 130, coupled to the video format conversion bridge chip 120 and the display screen 20 respectively, is configured to receive the converted main video signals or the converted external video signals from the video format conversion bridge chip 120, and conduct frame rate conversion (frame rate conversion, FRC) on the converted main video signals or the converted external video signals based on motion estimation and motion compensation (motion estimation and motion compensation, MEMC) principle, so as to process the converted main video signals or the converted external video signals into high resolution and high frame rate video signals, for example, improve the video contents with a common refresh rate of 60 Hz to video contents with a refresh rate of 120 Hz or 240 Hz, and then transmit the high resolution and high frame rate video signals to the display screen 20 to play, thus improving the definition of motion pictures.

It should be illustrated that the motion compensation frame rate converter 130 is also configured to receive the on screen display menu data from the video format conversion bridge chip 120 and overlay the on screen display menu data with the converted external video signals. Moreover, for the overlaying operation, the on screen display menu data may be overlaid with the converted external video signals firstly, and then the external video signals overlaid with the on screen display menu data are processed into high resolution and high frame rate video signals; or, after the converted external video signals are processed into high resolution and high frame rate video signals, the on screen display menu data is overlaid. The above manners are only different in the overlaying sequences, and can both present high definition pictures with on screen display menu data on the display screen 20; therefore, the above overlaying sequences are not intended to limit the present invention.

The operation mode of the audio and video player 10 disclosed by the embodiment of the present invention will be illustrated hereinafter through a specific implementation manner.

After receiving the audio and video signals from the main signal source 30, the processor 110 of the audio and video player 10 transmits the main audio signals from the main signal source 30 to the audio system 40 through an I²S audio bus; and transmits the main video signals from the main signal source 30 to the video format conversion bridge chip 120 through the first video format output interface 112. During this process, the processor 110 may also produce corresponding on screen display menu data through the on screen display menu function module 111 according to the external operation instruction received, and overlay the on screen display menu data with the main video signals, then transmit the main video signals overlaid with the on screen display menu data to the video format conversion bridge chip 120. Therefore, the main video signals transmitted by the processor 110 to the video format conversion bridge chip 120 may either be the main video signals overlaid with on screen display menu data, or the main video signals not overlaid with on screen display menu data yet. In the embodiment, it is illustrated that the main video signals transmitted to the video format conversion bridge chip 120 are the main video signals overlaid with on screen display menu data, but are not limited to this. Moreover, during the process of transmitting the overlaid main video signals, the processor 110 optionally converts the data format of the overlaid main video signals into a data format suitable for the first video format output interface 112 according to actual demands, such as HDMI, and then transmits the signals to the video format conversion bridge chip 120 through the first video format output interface 112.

The video format conversion bridge chip 120 receives the foregoing overlaid main video signals through the first video format input interface 121, and converts the data format of the main video signals into data format V-by-One from data format HDMI, and then transmits the converted main video signals to the motion compensation frame rate converter 130 through the second video format output interface 123.

Next, after receiving the converted main video signals through the second video format input interface 131, the motion compensation frame rate converter 130 conducts motion estimation, motion compensation and frame rate conversion on the converted main video signals, so that the converted main video signals are processed into high resolution and high frame rate video signals. Then, the high resolution and high frame rate video signals are transmitted to the display screen 20 to play, thus presenting high definition pictures with on screen display menu data on the display screen 20.

Furthermore, when the audio and video signals inputted into the audio and video player 10 are from an external signal source of such an audio and video output equipment like a DVD player or a set top box or the like, the audio and video player 10 receives the external audio and video signals through the external audio and video input interface 124 of the video format conversion bridge chip 120. Wherein, the external audio signals from the external signal source are transmitted to the processor 110 through the audio output interface 125 of the video format conversion bridge chip 120, and then provided to the audio system 40 to play through the processor 110. While the data format of the external video signals from the external signal source (i.e., the video signals in the audio and video signals of the external signal source) is converted through the video format conversion bridge chip 120, for example, converted into data format V-by-One from data format HDMI, so that the data format is consistent with the output format of the second video format output interface 123, and then the converted external video signals are transmitted to the motion compensation frame rate converter 130 through the second video format output interface 123, to facilitate conducting high resolution and/or high frame rate processing. For example, if the resolution of the external video signals is maximum resolution, resolution processing is not conducted in this case; on the contrary, the resolution of the video signals is processed into maximum resolution if the resolution is not maximum resolution. For example, when the inputted external video signals have 4K*2K resolution, then the video signals are not processed; if the inputted external video signals have 1080P resolution only, then the external video signals are processed to have 4K*2K resolution.

Wherein, during the process of transmitting the external video signals from the video format conversion bridge chip 120 to the motion compensation frame rate converter 130, if the processor 110 receives an external operation instruction to produce corresponding on screen display menu data through the on screen display menu function module 111, the video format conversion bridge chip 120 receives the on screen display menu data through the first video format input interface 121 and converts the data format, so that the data format of the on screen display menu data is converted into the data format that can be received by the on screen menu input interface 132 of the motion compensation frame rate converter 130, and then the on screen display menu data is transmitted to the motion compensation frame rate converter 130 through the on screen menu output interface 126. It is to be understood that if the initial data format of the on screen display menu data is consistent with the data format that can be received by the on screen menu input interface 132 of the motion compensation frame rate converter 130, the operation of converting the data format can be omitted.

Then, the motion compensation frame rate converter 130 can namely overlay the received on screen display menu data with the external video signals; or overlay the received on screen display menu data with the external video signals which are processed into high resolution and high frame rate video signals already, and then transmits to the display screen 20.

Therefore, the audio and video player provided by the embodiment of the present invention may optionally receive the audio and video signals from the main signal source through the processor; or receive the audio and video signals from the external signal source through the video format conversion bridge chip, and select corresponding processing mode according to different signal sources. Meanwhile, in the audio and video player provided by the embodiment of the present invention, the audio and video player is enabled to possess the ability of processing large-scale software, for example, large-scale games or other high power consumption software, through a manner of configuring the processor having performance indexes apparently higher than that of a general processor. Moreover, the main video signals received by the processor or the external video signals received by the video format conversion bridge chip can be played on the display screen and the on screen display menu data can be presented at the same time by serving the video format conversion bridge chip as the medium for transmitting the main video signals, the external video signals and the on screen display menu data, and capable of converting the data format of the main video signals, the external video signals and the on screen display menu data. Moreover, high resolution and high frame rate video signals may be provided to the display screen through optimizing the converted video signals by the motion compensation frame rate converter, thus improving the quality of the display picture, and increasing the user experience at the same time.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in the embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer equipment (which may be a personal computer, a server, or a network equipment so on) to execute the method according to each embodiment or some parts of the embodiments.

The audio and video player provided by the present application is enabled to possess the ability of processing large-scale software, for example, large-scale games or other high power consumption software, through a manner of configuring the processor having performance indexes apparently higher than that of a general processor. Moreover, the external video signals received by the video format conversion bridge chip can be played on the display screen and the on screen display menu data can be presented at the same time by serving the video format conversion bridge chip as the medium for transmitting the external video signals and the on screen display menu data, and capable of converting the data format of the external video signals and the on screen display menu data. Moreover, high resolution and high frame rate video signals may be provided to the display screen through optimizing the converted video signals by the motion compensation frame rate converter, thus improving the quality of the display frame, and increasing the user experience at the same time.

It should be finally noted that the above embodiments are only configured to explain the technical solutions of the present invention, but are not intended to limit the present invention. Although the present invention has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of the embodiments of the present invention.

What is claimed is:

1. An audio and video player, comprising: a processor, a video format conversion bridge chip and a motion compensation frame rate converter, wherein,
the processor, provided with an on screen display menu function module, is configured to produce on screen display menu data;
the video format conversion bridge chip, which is coupled to the processor and the motion compensation frame rate converter respectively, and may be optionally coupled to an external signal source, is configured to receive the on screen display menu data, and receive and convert the data format of external video signals from the external signal source, and transmit the converted external video signals and the on screen display menu data to the motion compensation frame rate converter respectively; and
the motion compensation frame rate converter, coupled between the video format conversion bridge chip and a display screen, is configured to receive and overlay the converted external video signals with the on screen display menu data and transmit to the display screen.

2. The audio and video player according to claim 1, wherein the processor is coupled to a main signal source, and the processor is configured to receive main video signals and main audio signals from the main signal source, overlay the main video signals with the on screen display menu data, and transmit to the video format conversion bridge chip.

3. The audio and video player according to claim 2, wherein the video format conversion bridge chip is further configured to receive and convert the data format of the main video signals, and the motion compensation frame rate converter is configured to process the converted main video signals and the overlaid external video signals into high resolution and high frame rate video signals.

4. The audio and video player according to claim 3, wherein a first video format output interface is electrically set on the processor;
a first video format input interface, a second video format output interface and an on screen menu output interface are electrically set on the video format conversion bridge chip; and
a second video format input interface and an on screen menu input interface are electrically set on the motion compensation frame rate converter;
wherein, the first video format input interface of the video format conversion bridge chip, coupled to the first video format output interface, is configured to receive the overlaid main video signals, the second video format output interface is coupled to the second video format input interface, is configured to transmit the converted main video signals or external video signals to the motion compensation frame rate converter, while the on screen menu output interface, coupled to the on screen menu input interface, is configured to transmit the on screen display menu data to the motion compensation frame rate converter.

5. The audio and video player according to claim 4, wherein an external audio and video input interface which is coupled to the external signal source is electrically set on the video format conversion bridge chip, and is configured to receive the external audio signals from the external signal source and the external video signals, wherein the video format conversion bridge chip converts the data format of the external audio signals, and transmits the converted external audio signals to the processor.

6. The audio and video player according to claim 5, wherein the data format of the on screen menu output interface and the first video format input interface are different, the data format of the on screen menu output interface and the on screen menu input interface are the same, the video format conversion bridge chip converts the data format of the on screen display menu data, and transmits the converted on screen display menu data to the motion compensation frame rate converter through the on screen menu output interface.

7. The audio and video player according to claim 5, wherein the data format of the first video format output interface and the external audio and video input interface is one of MHL, HDMI, LVDS, DP, EDP, MIPI DSI, TTL and combinations thereof, the data format of the first video format input interface is the same as the data format of the first video format output interface, the data format of the second video format output interface is different from the data format of the first video format output interface, and the second video format output interface and the second video format output interface are a video signal output interface and a video signal input interface with corresponding data format.

8. The audio and video player according to claim 7, wherein the data format of the second video format output interface is V-by-One.

9. The audio and video player according to claim 2, wherein the audio and video player is a TV set, wherein the main signal source is a TV signal source, a signal source from internet or a signal source downloaded from a local end, and the external signal source is an audio and video signal source of a video and audio device externally connected to the audio and video player.

10. The audio and video player according to claim 5, wherein the processor is also coupled with an audio system, wherein the processor receives the main audio signals and/or the external audio signals from the external signal source, and transmits the main audio signals and/or the external audio signals to the audio system, wherein an audio output interface which is coupled to the processor is electrically set on the video format conversion bridge chip, and is configured to transmit the external audio signals to the processor 11. The audio and video player according to claim 6, wherein the data format of the first video format output interface and the external audio and video input interface is one of MHL, HDMI, LVDS, DP, EDP, MIPI DSI, TTL and combinations thereof, the data format of the first video format input interface is the same as the data format of the first video format output interface, the data format of the second video format output interface is different from the data format of the first video format output interface, and the second video format output interface and the second video format output interface are a video signal output interface and a video signal input interface with corresponding data format.
